(19) United States
(12) Patent Application Publication
(10) Pub. No.: US 2024/0202517 A1
(43) Pub. Date: Jun. 20, 2024

(54) DOCUMENT PROCESSING WITH EFFICIENT TYPE-OF-SOURCE CLASSIFICATION

(71) Applicant: ABBYY Development Inc., Dover, DE (US)

(72) Inventors: Ivan Zagaynov, Moskovskaya (RU); Dmitry Solntsev, Moscow (RU); Alena Vasileva, Sverdlovskaya (RU)

(21) Appl. No.: 18/084,140

(22) Filed: Dec. 19, 2022

(51) Int. Cl. G06N 3/08; G06N 7/01

(52) U.S. Cl. CPC G06N 3/08; G06N 7/01

(57) ABSTRACT

Aspects and implementations provide for techniques of classifying images by source types for efficient, fast, and economical processing of such images. The disclosed techniques include, for example, obtaining an input into an image processing operation (IPO input). The techniques further include processing, using a first neural network (NN), a first image associated with the IPO input to obtain a first feature vector, and processing, using a second NN, a plurality of second images associated with the IPO input to obtain a second feature vector. The techniques further include identifying, using the first feature vector and the second feature vector, a type of source used to generate the IPO input.

### TECHNICAL FIELD

The implementations of the disclosure relate generally to computer systems and, more specifically, to systems and methods for classifying images of documents and efficiently extracting information from such documents.

### BACKGROUND

Detection and recognition of texts and objects in unstructured electronic documents is an important task in processing, storing, and referencing documents. Electronic documents can be obtained using a variety of devices and techniques including scanning, photographing, digital synthesis, and the like, often resulting in images of very different quality and appearance.

### SUMMARY OF THE DISCLOSURE

Implementations of the present disclosure are directed to efficient, fast, and economical techniques for preprocessing of images of diverse source types, e.g., photographic images, video camera images, scanned images, synthetic (digital) images, and the like. Reliability and precision of various computer vision techniques, such as optical character recognition, object recognition, and the like, are often significantly improved by appropriate image preprocessing, e.g., filtering, denoising, lighting/color modification, and so on. Knowledge of the source type of an image enables a custom selection of those preprocessing techniques that maximize the likelihood of successful application of computer vision algorithms.

In one implementation, a method of the disclosure includes obtaining an input into an image processing operation (IPO input). The method further includes processing, using a first neural network (NN), a first image associated with the IPO input to obtain a first feature vector; and processing, using a second NN, a plurality of second images associated with the IPO input to obtain a second feature vector. The method further includes identifying, using the first feature vector and the second feature vector, a type of source used to generate the IPO input.

In another implementation, a method of the disclosure includes obtaining an input image and a metadata associated with the input image and generating, using the metadata, a metadata feature vector. The method further includes processing, using a trained metadata classifier, the metadata feature vector to generate a plurality of probabilities. Each of the plurality of probabilities characterizes a likelihood that the input image is associated with a respective image source type of a plurality of image source types. The method further includes identifying, using the plurality of probabilities, a type of source used to generate the input image.

In yet another implementation, a system of the disclosure includes a memory and a processing device communicatively coupled to the memory. The processing device is to obtain an IPO input and process, using a first NN, a first image associated with the IPO input to obtain a first feature vector. The processing device is further to process, using a second NN, a plurality of second images associated with the IPO input to obtain a second feature vector. The processing device is further to identify, using the first feature vector and the second feature vector, a type of source used to generate the IPO input.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 is a block diagram of an example computer system in which implementations of the disclosure may operate, in accordance with some implementations of the present disclosure.

FIG. 2A illustrates example operations of metadata-based classification of images by source types, in accordance with some implementations of the present disclosure.

FIG. 2B further illustrates operations of a metadata processing model that may be used in the context of the example operations of FIG. 2A, in accordance with some implementations of the present disclosure.

FIG. 3 illustrates example operations of classification of images by source types based on global and local appearance of the images, in accordance with some implementations of the present disclosure.

FIG. 4 illustrates patches cropped from an example input image of a document, in accordance with some implementations of the present disclosure.

FIG. 5A illustrates example input images and patches cropped from the example input images associated with different source types, in accordance with some implementations of the present disclosure.

FIG. 5B is a side-by-side view of some of the cropped patches of FIG. 5A.

FIG. 6 is a flow diagram illustrating an example method of metadata-based classification of images by source types, in accordance with some implementations of the present disclosure.

FIG. 7 is a flow diagram illustrating an example method of classification of images by source types based on a combination of global and local appearance features of the images, in accordance with some implementations of the present disclosure.

FIG. 8 depicts an example computer system that can perform any one or more of the methods described herein, in accordance with some implementations of the present disclosure.

### DETAILED DESCRIPTION

Manual processing of documents is a slow and expensive task and, therefore, efficient techniques of automated image processing are highly desirable. Correct classification of images is important for their efficient automated processing. Electronic images can belong to a very large number of types (classes). Classifications may be performed by a content of the images (e.g., documents, portraits, scenes, etc.), a nature of the images (e.g., real or artificial), origin of the images (e.g., specific companies, vendors, government organization, or other originators), and so on. Images of documents may be further subdivided into various sub-classes, e.g., bills, checks, purchasing orders, invoices, receipts, bills of lading, inventory lists, etc. It may often be advantageous to classify the images among source types, e.g., scanned documents, photographed documents, synthetic images, and so on.

Images of specific source types often share similar artifacts that hinder efficient processing of those images, such as optical character recognition (OCR) processing used to identify letters, words, and sentences, and/or object recognition (OR) processing used to identify depictions of objects, drawings, plots, logos, and other graphics elements. For example, scanned images often have global geometric artifacts, such as a tilt or a rotation of the document, and/or local artifacts, such as inclusion of extraneous elements (e.g., a portion of an adjacent document or a different page of the same document). Photographed images may have perspective artifacts, non-uniformity of lighting, blur, glare, dark patches, noise, and so on. Efficiency of OCR and OR processing is often significantly improved with an application of appropriate artifact removal tools. However, the techniques that work well for photographed images may be suboptimal for scanned documents (and vice versa), and applying such techniques to documents of a wrong source type may even be detrimental for successful content extraction. Similarly, synthetic images can be free (or nearly-free) from artifacts and may be better OCR/OR-processed without any artifact removal or with minimal preprocessing, such as with a simple alignment correction of the image (e.g., rotation and/or parallel shift). As a result, applying the same set of artifact removal techniques to images of different origins may result in an insufficient preprocessing for some images and excessing, unnecessary, and/or incorrect preprocessing for other images. Accordingly, correctly pre-classifying images by the source type may significantly improve quality of image processing. Existing techniques of image source type identification are often directed to specialized tasks, e.g., identification of an owner of an image, creator of an image, time of its initial creation and/or subsequent modifications, and so on, which may be performed in the context of law enforcement. Such specialized techniques typically have a high computational complexity and are not readily scalable for large-volume industrial applications.

Aspects and implementations of the present disclosure address the above noted and other challenges of the existing technology by providing for systems and techniques that efficiently classify images among a number of source types. In some implementations, source types (also often referred to as classes throughout this disclosure) may include a scan, a photograph, a synthetic image, and/or the like. In some implementations, a photograph class may be split into multiple classes (or sub-classes), such as low-quality photographs (such as images acquired with a phone camera) and high-quality photographs (such as images acquired with a more advanced, e.g., professional, camera). Other classes may be defined as relevant in a given application or context. In some implementations, image classification may be performed using a two-stage process. For example, during a first stage, metadata associated with the image may be extracted and encoded in form of a feature vector that may be processed using a suitable machine-learning model (MLM) or some other classifier to classify the image among various classes. In some implementations, the MLM may include a regression-based classifier, e.g., a gradient boosting classifier or some other similar classifier. The first metadata-based stage of the two-stage process may output probabilities characterizing the likelihood that the image belongs to various target classes.

In those instances where no single prediction matches a threshold (target) probability, the image may undergo a second stage processing. The second stage may include a number of MLMs, some of which may be trained neural network (NN) models. In some implementations, a first NN model may process the whole image (which may be suitably downscaled or even upscaled, as appropriate) and a second NN model may process cropped portions (also referred to as patches herein) of the image. The first NN model and the second NN model may include multiple layers of neural convolutions and may output feature vectors that encode the global appearance of the image and the local appearance of image portions, respectively. The output feature vectors may be joined (e.g., concatenated) and processed by a trained classifier, e.g., a classifier that includes one or more fully-connected layers. The output of the classifier may include final probabilities that the image belongs to one or of the target classes. A class associated with the highest final probability may be accepted as the predicted class for the image. The predicted class may then be used for selecting a preprocessing routine prescribed for the respective predicted class. The preprocessing routine may include denoising, edge cropping, defect (e.g., lines, dots) removal, lighting modification, glare removal, brightness homogenization, contrast/color sharpening, and the like. The classified and suitably preprocessed image may subsequently undergo OCR, OR, and/or other computer vision techniques for extraction of any suitable content from the image, including but not limited to any set of alphanumeric strings, graphical elements, and the like.

Numerous additional implementations are disclosed herein. The advantages of the disclosed systems and techniques include but are not limited to efficient, reliable, and economical classification of images among target source types for identification of an optimal preprocessing routine that is to be applied to the images for maximizing the success of content extraction. The disclosed techniques allow customized processing of images by facilitating selection of optimal preprocessing tools that are applied to the images. Correspondingly, image processing avoids application of unnecessary tools (thus saving valuable processing resources) and tools whose application is inadequate or detrimental for the quality of processing tasks being performed while allowing application of the full repertoire of such tools in those instances where such application is beneficial.

As used herein, an “image” may refer to any set of digital data representative of an appearance of any scenery or environment or any portion thereof or object(s) located therein. The appearance may be capable of being perceived directly, e.g., by a human being (e.g., via visible electromagnetic waves), and/or indirectly, e.g., via any suitable detection device or a collection of such devices (e.g., via visible electromagnetic waves, infrared electromagnetic waves, ultraviolet electromagnetic waves, and/or any other signals representative of an appearance of an environment and/or objects). In one non-limiting example, an image may include a depiction of a document.

As used herein, a “document” may refer to any collection of symbols, such as words, letters, numbers, glyphs, punctuation marks, barcodes, pictures, logos, etc., that are printed, typed, handwritten, stamped, signed, drawn, painted, and the like, on a paper or any other physical or digital medium from which the symbols may be captured and/or stored in a digital image. A “document” may represent a financial document, a legal document, a government form, a shipping label, a purchasing order, an invoice, a credit application, a patent document, a contract, a bill of sale, a bill of lading, a receipt, an accounting document, a commercial or governmental report, or any other suitable document that may have one or more fields of interest. A document may include any region, portion, partition, table, table element, etc., that is typed, written, drawn, stamped, painted, copied, and the like. A document may be captured in any suitable scanned image, photographed image, or any other representation capable of being converted into a data form accessible to a computer. In accordance with various implementations of the present disclosure, an image may conform to any suitable electronic file format, such as PDF, DOC, ODT, JPEG, BMP, etc.

An image may include one or more artifacts. As used herein, an “artifact” may include any feature or effect that is not introduced purposefully and/or does not represents an integral part of the object/environment being imaged and arises in the course of any part of document acquisition and/or processing, including but not limited to any noise, marks, defects of photography or scanning, such as lighting non-uniformity, spurious lines and dots, tilt, rotation, cropping, or any other, image imperfections.

The techniques described herein may involve training one or more neural networks to process images, e.g., to classify images among any number of target classes of interest. The neural network(s) may be trained using training datasets that include various scanned, photographed, and/or synthetic images, or any combination thereof. During training, neural network(s) may generate a training output for each training input. The training output of the neural network(s) may be compared to a desired target output as specified by the training data set, and the error may be propagated back to various layers of the neural network(s), whose parameters (e.g., the weights and biases of the neurons) may be adjusted accordingly (e.g., using a suitable loss function) to optimize prediction accuracy. Trained neural network(s) may be applied for efficient, reliable, and economical classification of any suitable images.

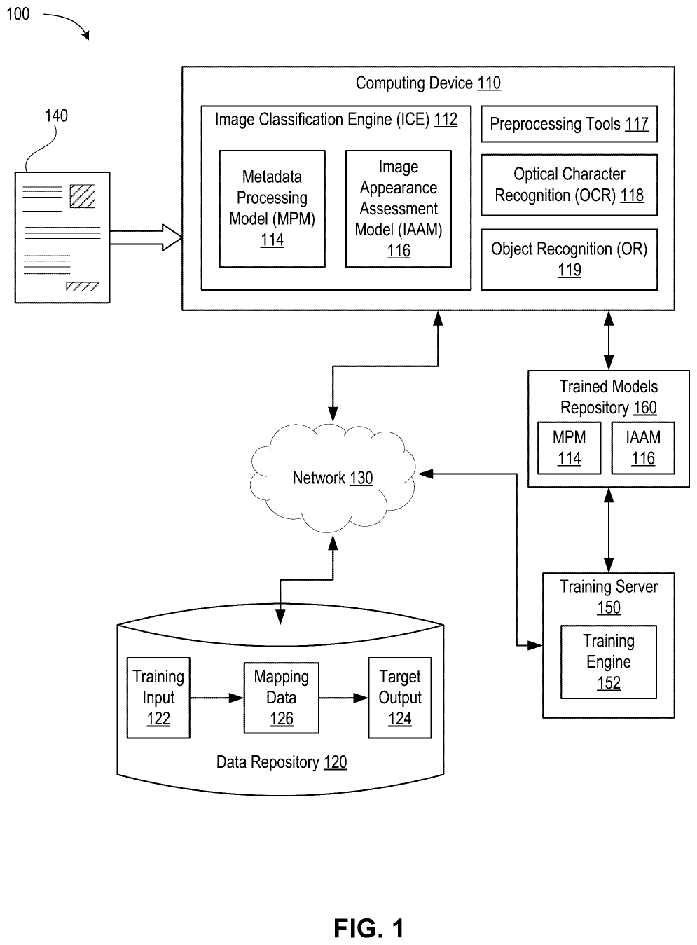

FIG. 1 is a block diagram of an example computer system 100 in which implementations of the disclosure may operate, in accordance with some implementations of the present disclosure. As illustrated, computer system 100 may include a computing device 110, a data repository 120, and a training server 150 connected via a network 130. Network 130 may be a public network (e.g., the Internet), a private network (e.g., a local area network (LAN), wide area network (WAN)), and/or a combination thereof.

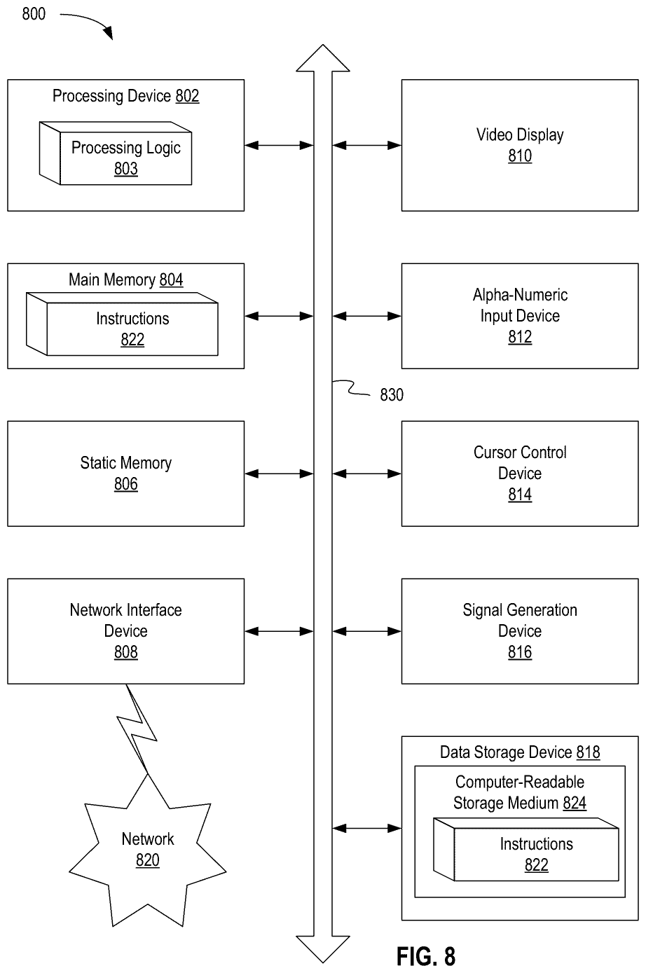

The computing device 110 may be a desktop computer, a laptop computer, a smartphone, a tablet computer, a server, a scanner, or any suitable computing device capable of performing the techniques described herein. In some implementations, the computing device 110 may be (and/or include) one or more computer systems 800 of FIG. 8.

Computing device 110 may receive an image 140 that may also include any people, objects, text(s), graphics, table(s), and the like. Image 140 may be received in any suitable manner. For example, computing device 110 may receive a digital copy of image 140 by scanning or photographing a document, an object, a scenery, a view, and so on. In some instances, image 140 may be a synthetic image, e.g., image created by a computing device, including but not limited to a document rendered by a computing program, such as a text document saved in a graphics format, a portable document format (PDF), a printable format, an image format (e.g., JPEG, GIFF, etc.), a video frame format (AVI, MP4, etc.), and/or any other media format, and may be generated by any image/video/media encoding engine, or may be any other image digital synthetic image. In those instances where computing device 110 is a server, a client device connected to the server via the network 130 may upload a digital copy of image 140 to the server. In the instances where computing device 110 is a client device connected to a server via the network 130, the client device may download image 140 from the server or from data repository 120.

Image classification engine (ICE) 112 may perform classification of image 140 by source type. In some implementations, ICE 112 may perform image classification in multiple stages. During the first stage, ICE 112 may perform metadata-based classification using metadata that may be associated (and/or stored or otherwise provided) with image 140. In some implementations, metadata-based classification may be performed using a metadata processing model (MPM) 114. MPM 114 may extract various metadata tags from the metadata associated with image 140, encode the extracted metadata via a suitable digital representation (feature vector), and process the digital representation using a trained classifier, e.g., a gradient boosting classifier, a neural network classifier, and/or the like. The trained classifier may estimate likelihoods (e.g., by outputting respective probabilities) that image 140 belongs to various predetermined classes (source types), such as a photographed image, a scanned image, a synthetic image, and/or the like. In those instances where the likelihoods are estimated with sufficient confidence, ICE 112 may take the maximum output likelihood as an indication of the actual source type of image 140.

In those instances where classifications output by MPM 114 are obtained with a low confidence (e.g., the maximum probability is below a target threshold) and/or in those instances where the metadata is absent or insufficient, ICE 112 may transition to the second stage. During the second stage, ICE 112 may perform classification of image 140 using an image appearance assessment model (IAAM) 116. IAAM 116 may include one or more neural networks trained to assess various image defects, imperfections, various features added during image acquisition, and/or any other artifacts indicative of specific image source types. IAAM 116 may assess both the global appearance of image 140, e.g., by processing the whole (though, possibly, downscaled) image 140, as well as the presence of source-specific local artifacts in image 140, e.g., by processing cropped portions (patches) of image 140. In some implementations, global appearance features and local appearance features may be encoded by separate encoder subnetworks of IAAM 116 and then combined together for processing by a classifier subnetwork of IAAM 116 that generates the final class probabilities. The ultimate classification of image 140 may then be made based on the maximum output final class probability.

Informed by the identified source type, computing device 110 (or any other computing device) may apply various preprocessing tools 117 to image 140. Preprocessing tools 117 may be selected to maximize quality of image 140 in view of the specific determined source type. In some instances (e.g., when image 140 has been determined to be an artifact-free synthetic image), no preprocessing tools 117 may be applied to image 140. The improved (modified) image 140 may then be used for any suitable purpose. For example, the improved (if so indicated by the identified source type) image 140 may undergo optical character recognition (OCR) 118 to determine one or more alphanumeric sequences depicted in image 140, e.g., letters, numerals, words, phrases, sentences, paragraphs, and/or the like. Similarly, image 140 may undergo object recognition (OR) 119 to identify one or more objects depicted in image 140, e.g., people, animals, inanimate objects (such as a building, a car, a road sign), graphics, figures, logos, stamps, letterheads, and/or the like. Any other computer vision operations or other source-type specific operations may be applied to image 140 in addition to (or instead of) OCR 118 and/or OR 119.

ICE 112, MPM 114, and/or IAAM 116 may include (or may have access to) instructions stored on one or more tangible, machine-readable storage media of computing device 110 and executable by one or more processing devices of computing device 110. In one implementation, ICE 112, MPM 114, and/or IAAM 116 may be implemented as a single component. ICE 112, MPM 114, and/or IAAM 116 may each be a client-based application or a combination of a client component and a server component. In some implementations, ICE 112, MPM 114, and/or IAAM 116 may be executed entirely on the client computing device such as a server computer, a desktop computer, a tablet computer, a smart phone, a notebook computer, a camera, a video camera, or the like. Alternatively, some portion of ICE 112, MPM 114, and/or IAAM 116 may be executed on a client computing device (which may receive image 140) while other portions of ICE 112, MPM 114, and/or IAAM 116 may be executed on a server device that performs ultimate classification of images. The server portion may then communicate image source types to the client computing device, for further processing of the images. Alternatively, the server portion may provide the image source types to another application. In other implementations, ICE 112, MPM 114, and/or IAAM 116 may execute on a server device as an Internet-enabled application accessible via a browser interface. The server device may be represented by one or more computer systems such as one or more server machines, workstations, mainframe machines, personal computers (PCs), etc.

A training server 150 may construct MPM 114 and/or IAAM 116 (or other machine learning models) and train MPM 114 and/or IAAM 116 to perform image classification among two or more classes. Training server 150 may include a training engine 152 that performs training of MPM 114 and/or IAAM 116. Training server 150 may be and/or include a rackmount server, a router computer, a personal computer, a portable digital assistant, a mobile phone, a laptop computer, a tablet computer, a camera, a video camera, a netbook, a desktop computer, a media center, or any combination of the above.

During training of MPM 114 and/or IAAM 116, training image(s) 140 may be appropriately prepared. For instance, training images 140 may be cropped, resized, rotated, and/or manually or automatically annotated with correct source type identifications. MPM 114 and/or IAAM 116 may be trained by the training engine 152 using training data (e.g., training images 140) that include training inputs 122 and corresponding target outputs 124 (ground truth that includes correct classifications for the respective training inputs 122). Training engine 152 may find patterns in the training data that map the training inputs to the target outputs (the desired result to be predicted), and train MPM 114 and/or IAAM 116 to capture these patterns. As described in more detail below, MPM 114 and/or IAAM 116 may include deep neural networks, with one or more hidden layers, e.g., convolutional neural networks, recurrent neural networks (RNN), and fully connected neural networks. The training data may be stored in data repository 120 and may also include mapping data 126 that maps training inputs 122 to target outputs 124. Target outputs 124 may include ground truth that include correct source type identifications of training inputs 122. During the training phase, training engine 152 may find patterns in the training data that can be used to map training inputs 122 to target outputs 124. The patterns can be subsequently used by MPM 114 and/or IAAM 116 for future predictions (inferences, classifications).

Data repository 120 may be a persistent storage capable of storing files as well as data structures to perform determination of field values in electronic documents, in accordance with implementations of the present disclosure. Data repository 120 be hosted by one or more storage devices, such as main memory, magnetic or optical storage disks, tapes, or hard drives, network-attached storage (NAS), storage area network (SAN), and so forth. Although depicted as separate from the computing device 110, data repository 120 may be part of computing device 110. In some implementations, data repository 120 may be a network-attached file server, while in other implementations data repository 120 may be some other type of persistent storage such as an object-oriented database, a relational database, and so forth, that may be hosted by a server machine or one or more different machines coupled to the via the network 130.

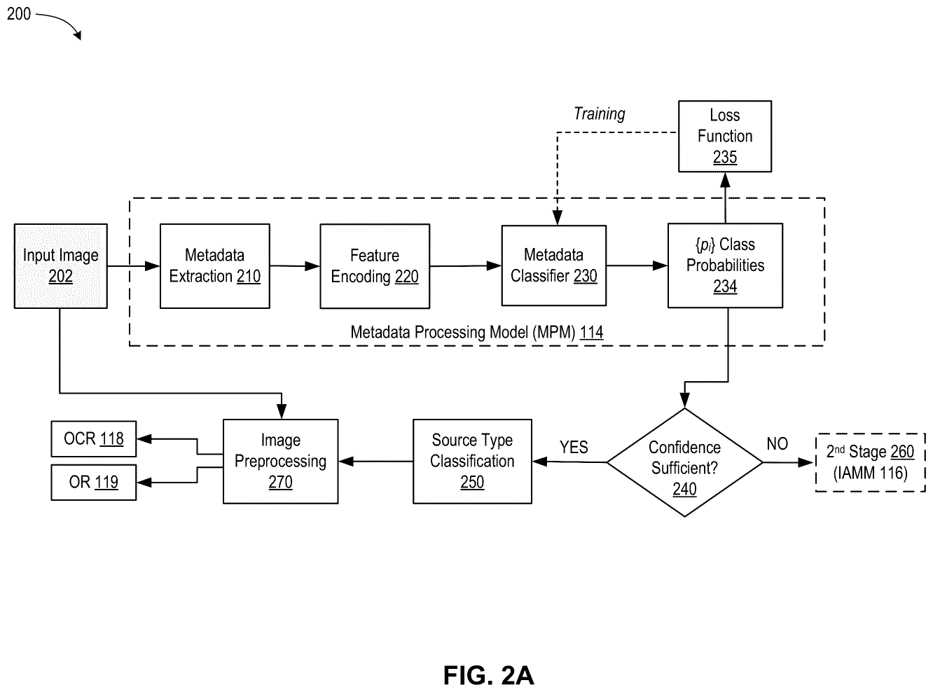

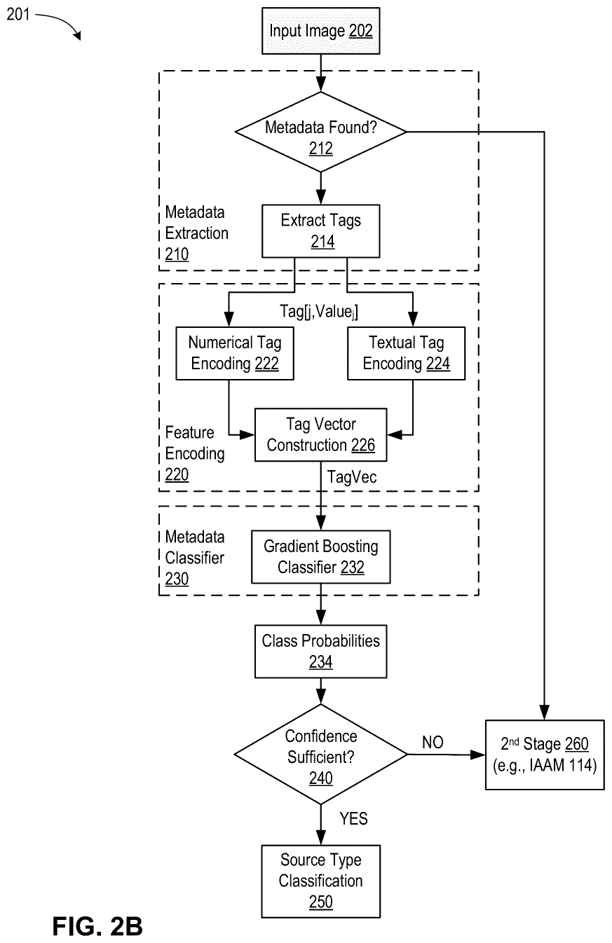

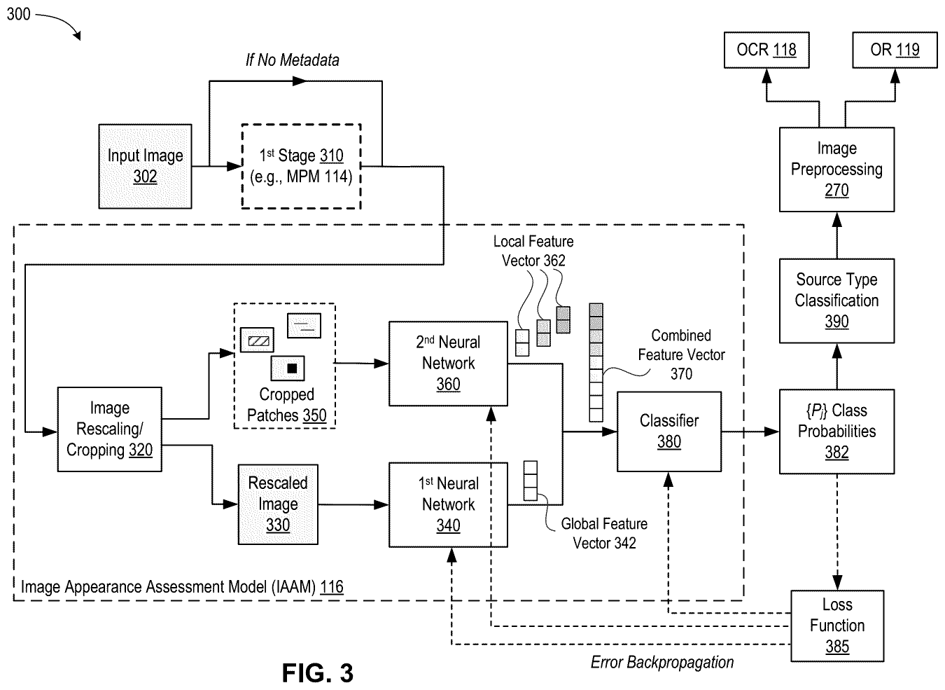

In some implementations, training engine 152 may train MPM 114 and/or IAAM 116 that include multiple neurons to perform classification tasks, in accordance with various implementations of the present disclosure. Each neuron may receive its input from other neurons or from an external source and may produce an output by applying an activation function to the sum of weighted inputs and a trainable bias value. A neural network may include multiple neurons arranged in layers, including an input layer, one or more hidden layers, and an output layer. Neurons from different layers may be connected by weighted edges. The edge weights are defined at the network training stage based on a training dataset that includes a plurality of images with known fields and field values. In one illustrative example, all the edge weights may be initially assigned some random values. For every training input 122 in the training dataset, training engine 152 may compare observed output of the neural network with the target output 124 specified by the training data set. The resulting error, e.g., the difference between the output of the neural network and the target output, may be propagated back through the layers of the neural network, and the weights and biases may be adjusted in the way that makes observed outputs closer to target outputs 124. This adjustment may be repeated until the error for a particular training input 122 satisfies a predetermined condition (e.g., falls below a predetermined error). Subsequently, a different training input 122 may be selected, a new output may be generated, and a new series of adjustments may be implemented, and so on, until the neural network is trained to a sufficient degree of accuracy. In some implementations, this training method may be applied to training one or more artificial neural networks or other machine-learning models, e.g., as illustrated in FIG. 2A, FIG. 2B, and/or FIG. 3.

After MPM 114 and/or IAAM 116 are trained, the set of MPM 114 and/or IAAM 116 may be stored in a trained models repository 160 (hosted by any suitable storage devices or a set of storage devices) provided to computing device 110 (and/or any other computing device) for inference analysis of new images. For example, computing device 110 may process a new image 140 using the provided MPM 114 and/or IAAM 116, identify source type classification of new image 140, perform and suitable preprocessing of new image 140, and use preprocessed image 140 for various tasks, including but not limited to OCR 118, OR 119, and/or any other computer vision tasks.

FIG. 2A illustrates example operations 200 of metadata-based classification of images by source types, in accordance with some implementations of the present disclosure. FIG. 2B further illustrates operations 201 of a metadata processing model (e.g., MPM 114) that may be used in the context of example operations 200 of FIG. 2A, in accordance with some implementations of the present disclosure. In some implementations, example operations 200 may be performed using example computer system 100 of FIG. 1. Input image(s) 202 may be image(s) of any single-page or multi-page document(s), images of indoor or outdoor scenery, images of people (portraits), groups of people, images of animals, things, machines, equipment, and so on, or any combination thereof. Input image(s) 202 may be generated using any suitable systems and techniques, including scanning, photographing, video camera imaging, computer synthesis, and the like, or any combination thereof. Input image(s) 202 may be self-standing images or images (frames) extracted from a stream of images (e.g., a video feed). In the instances where input image(s) 202 depict documents, the documents may include any region, portion, partition, table, table element, etc., that is typed, handwritten, drawn, stamped, painted, copied, and the like.

Input image 202 may be processed by MPM 114, which may include one or more modules, as illustrated in FIG. 2A and further illustrated in more detail in FIG. 2B. More specifically, input image 202 may be processed by a metadata extraction module 210. As illustrated in FIG. 2B, metadata extraction module 210 may determine (at block 212) whether any metadata is associated with input image 202. If the metadata is available, metadata extraction module 210 may extract (at block 214) various metadata tags available for input image 202. In some implementations, metadata may comport to the Exchangeable Image File Format (EXIF) or any other suitable standard that is used by video cameras, photographic cameras (including smartphone cameras), scanners, and other systems generating or processing image and/or media files recorded by digital imaging instruments. Such metadata may be added to images generated in some formats (e.g., JPEG format, TIFF format, and the like) and may be absent for images of some other formats. The metadata may include one or more metadata tags, which may include various information about the camera, camera settings, scenery, geolocation data, copyright information, and/or other information. Some of the metadata tags may have numerical values (referred to as numerical tags herein), e.g., a focal length, a focal plane resolution, a focal plane resolution unit, an exposure index, an exposure time, an F-number, a shutter speed value, an aperture value, a brightness value, a subject distance, a metering mode, a light source, a flash, an exposure program, a spatial frequency response, a spectral sensitivity, a focal plane resolution, an opto-electronic conversion function, an exposure mode, and/or the like. Some of the metadata tags may have textual values (referred to as textual tags herein, broadly understood to also include a combination of textual and numerical values), e.g., a manufacturer of the camera, a model of the camera, a file source, a scene type, and/or the like.

Extracted metadata tags may be encoded by a feature encoding module 220 that maps tag values to tag vectors using a certain mapping function ƒ(·), suitably chosen. For example, jth metadata tag Tag[j, Valueⱼ] with value Valueⱼ may be used as an input into the mapping function to obtain jth component of a tag vector TagVec[j]=f(Tag[j, Valueⱼ]). In some implementations, for numerical metadata tags, the mapping function ƒ(·) may output binary values 0 or 1. For example, when jth metadata value is absent, the mapping function ƒ(·) may output value 0, when jth metadata is present, the mapping function ƒ(·) may output value 1. In some implementations, the mapping function ƒ(·) may output a multi-bit value, e.g., a 2-bit value, 4-bit value, 6-bit value, 8-bit value, and/or the like. In some implementations, the mapping function ƒ(·) may be a hash function that outputs a fixed-length value for inputs of arbitrary lengths. In some implementations, a mapping function ƒ_{N}(·) used for encoding of numerical tags (e.g., using numerical tag encoding 222 in FIG. 2B) may be different from a mapping function ƒ_{T}(·) used for encoding of textual tags (e.g., using textual tag encoding 224 in FIG. 2B). In some implementations, a single mapping function may be used for encoding of both numerical tags and textual tags. In some implementations, mapping function ƒ(·) may be a two-part operation. During the first part, various characters and numerals of the metadata tags may be binarized using any suitable binarization scheme, e.g., the ASCII scheme. During the second part, the binarized values may be processed by a hash function that outputs fixed-length tag vector components TagVec[j].

The set of tag vector components {TagVec[j]} may be joined, e.g., concatenated (e.g., by tag vector construction 226 in FIG. 2B) into the tag vector, TagVec=(TagVec[1], TagVec[2], . . . ). The tag vector may be N=n×m bits long, where n is the number of different tag vector components and m is the number of bits in each component. The order in which different tag vector components are concatenated may be selected in an arbitrary manner (e.g., during training), but once selected, may be maintained for processing of images of various kinds (e.g., both for processing of training images and inference images).

The tag vector TagVec may be processed using a metadata classifier 230. In some implementations, metadata classifier 230 may be a gradient boosting classifier 232, as depicted in FIG. 2B. In some implementations, gradient boosting classifier 232 may be implemented as a decision tree classifier. In some implementations, the gradient boosting classifier 232 may operate by defining a regression function that uses the N bits of TagVec as an input, e.g., a regression function with randomly chosen or equal coefficients, and learning the values of those coefficients using various methods of gradient boosting (e.g., the gradient descent technique) to minimize a difference between outputs of metadata classifier 230 and corresponding target outputs (ground truth).

In some implementations, the training inputs may include tag vectors of a batch of training images and the target outputs may include correct classifications of the training images among a set of defined classes {cᵢ}. For example, class c₁ may be a scanned image class, class c₂ may be a photographed image class, and class c₃ may be a synthetic image class. In some implementations, the number of defined classes may be less than three or more than three and may be contingent on the types of images encountered in a particular task-specific context and may further depend on the desired accuracy of image classification. For example, class c₁ may be an image scanned by a desk scanner, class c₂ may be a class of images scanned by a phone-based scanning application, class c₃ may be a class of images taken with a professional camera, class c₄ may be a class of images taken with a phone camera, class c₅ may be a class of synthetic images, and so on.

In some implementations, metadata classifier 230 does not deploy a gradient boosting classifier 232 and includes a neural network-based classifier, e.g., a classifier having one or more fully-connected neuron layers and an output layer, e.g., a softmax layer, or any similar layer that converts logits output by the fully-connected layer(s) into a set of class probabilities 234. Class probabilities {pᵢ} may characterize the likelihood that a given image belongs to one of the corresponding classes {cᵢ}. In some instances, the set of probabilities {pᵢ} is not normalized, Σᵢpᵢ<1, and the catchall probability p₀=1−Σᵢpᵢ may corresponds to the image being classified as an “unknown” source type (class c₀).

At decision-making block 240, operations 200 of metadata-based classification may include determining whether a confidence condition is satisfied, e.g., whether a confidence of the obtained classification results is sufficient. In some implementations, the largest value pₘₐₓ among the set of determined class probabilities {pᵢ} may be compared with the threshold probability p_{T}. Provided that pₘₐₓ>p_{T} (or, in some implementations, pₘₐₓ≥p_{T}), the metadata-based classification may be deemed successful and the class cₘₐₓ identified with probability pₘₐₓ may be determined as the correct source type classification 250 for input image 202. Based on the determined source type classification 250, input image 202 may undergo image preprocessing 270 customized for the determined source type, which may be followed with OCR 118, OR 119, and/or any other computer vision techniques as may be defined by the user. The threshold probability p_{T} may be empirically selected during training (or validation) of MPM 114. In some implementations, the threshold probability p_{T} may be set at 0.85, 0.90, 0.93, 0.98, and/or any other suitable value.

If at decision-making block 240, it is determined the obtained the generated probabilities fail to satisfy the confidence condition, e.g., that pₘₐₓ≤p_{T} (or pₘₐₓ≤p_{T}), the metadata-based classification may be deemed unsuccessful and operations 200 may continue to a second stage 260 of image classification (as illustrated in FIG. 2B). In some implementations, operations of the second stage 260 may include using the image appearance assessment model (IAAM) 116 for more accurate determination of the correct source type of input image 202.

In some implementations, the success of the metadata-based classification performed by MPM 114 may be additionally assessed based on the probability p₀ of input image 202 belonging to the unknown class c₀. For example, if the probability p₀ exceeds a certain lower threshold p_{L} (p₀>p_{L}), this may signal a low confidence of the metadata-based classification. Correspondingly, in such implementations, the classification process may transition to IAAM 116 regardless of the relationship between pₘₐₓ and p_{T}.

Training metadata classifier 230 may be facilitated by a loss function 235, e.g., a logistic loss function, which may be minimized using the LogicBoost algorithm or any other similar algorithm. In some implementations, various other loss functions may be used, e.g., the mean-squared error loss function, the absolute error loss function, the cross-entropy loss function, the hinge loss function, and/or any other suitable loss function. In one example non-limiting implementation, metadata classifier 230 is a decision tree-based classifier with an ensemble of 50-200 different decision trees, a tree depth of 5-15 levels, and a learning rate within the 0.01-0.3 range.

In those instances where no metadata associated with input image 202 is detected (e.g., as depicted with block 212 in FIG. 2B), image classification may continue directly to the second stage 260. In some implementations, synthetic input images 302 may not have any associated metadata; in such instances a corresponding class (e.g., C₃ or C₅, as referenced above) may not be defined and such input images may go directly to the second stage 260.

FIG. 3 illustrates example operations 300 of classification of images by source types based on global and local appearance of the images, in accordance with some implementations of the present disclosure. In some implementations, example operations 300 may be performed by IAAM 116 of FIG. 1. In some implementations, example operations 300 may be performed as part of the second stage of the image classification process, in which the first stage includes the metadata-based classification. More specifically, example operations 300 may include processing a received input image 302 using the first stage 310 (the metadata-based classification), e.g., using MPM 114, as disclosed in more detail relation to FIGS. 2A-2B. If input image 302 lacks associated metadata or if the metadata-based classification does not succeed or generates a low confidence result (e.g., the determined class probabilities are below the threshold probability p_{T}), input image 302 may be processed by an image rescaling and cropping module 320. Image rescaling and cropping module 320 may scale input image 302 to any predetermined size, e.g., 640×360 pixels, 224×224 pixels, or any other size, to obtain a rescaled image 330. The specific dimensions of rescaled image 330 may be determined by a number of input channels of a neural network model trained to process rescaled image 330, as explained in more detail below.

Rescaled image 330 may be obtained using any suitable interpolation techniques, such as a bilinear interpolation algorithm. For example, if rescaled image 330 is downscaled by a scaling factor α along the horizontal (x) direction and by a scaling factor β along the vertical (y) direction (α and β may be any integer or non-integer numbers), a pixel (x, y) of the rescaled image 330 may be obtained by determining coordinates of the corresponding point (X, Y)=(αx, βy) in input image 302, identifying a number of reference pixels (e.g., two pixels along each of the two directions) in input image 302 whose centers are the closest to the point (X, Y), and computing intensity I(x, y) of the pixel of rescaled image 330 using linear interpolation from the intensities of the identified reference pixels. In some implementations, multiple pixels along each direction may be identified as reference pixels and the interpolation may be performed using splines of nonlinear functions, e.g., polynomial functions. In the instances of color images, similar rescaling may be used to compute intensities Iⱼ(x, y) for each color channel, e.g., j=R, G, B, channels or j=C, M, Y, K channels, or for any other color scheme.

In some implementations, rescaled image 330 may be a thumbnail image, a preview image, and the like. In some implementations, the preview image may be included as part of image metadata and used as rescaled image 330 directly, without additional rescaling by image rescaling and cropping module 320.

In some implementations, rescaling along at least one direction may include upscaling along at least one direction (α<1 and/or β<1). Such situations may arise, for example, when a preview image or a thumbnail image of input image 302 is received as part of the metadata and the size of the preview/thumbnail image is less than the size of the image expected by the neural network model trained to process rescaled image 330. In such situations, a bilinear interpolation or some other (e.g., spline) interpolation may be similarly used to upscale the preview/thumbnail image along one or more directions.

Rescaled image 330 may be processed by a trained first neural network 340 to generate a global feature vector 342 that represents a digital encoding of the global appearance of input image 302 as a whole. In some implementations, the first neural network 340 may be a convolutional neural network with multiple layers of neurons. In some implementations, the first neural network 340 may have one or more blocks that include an expansion layer, a layer of convolutions (e.g., depth-wise convolutions across different pixel channels of rescaled image 330), and a layer of compression. In some implementations, the first neural network 340 may have one or more residual (skipping) connections between layers or blocks of layers. In some implementations, the first neural network 340 may include one or more squeeze-and-excitation blocks. In some implementations, the first neural network 340 may have one or more bottleneck residual blocks with 3×3 convolutions, 5×5 convolutions, and so on. In some implementations, the first neural network 340 may have a MobileNetV3 architecture or a similar neuron architecture.

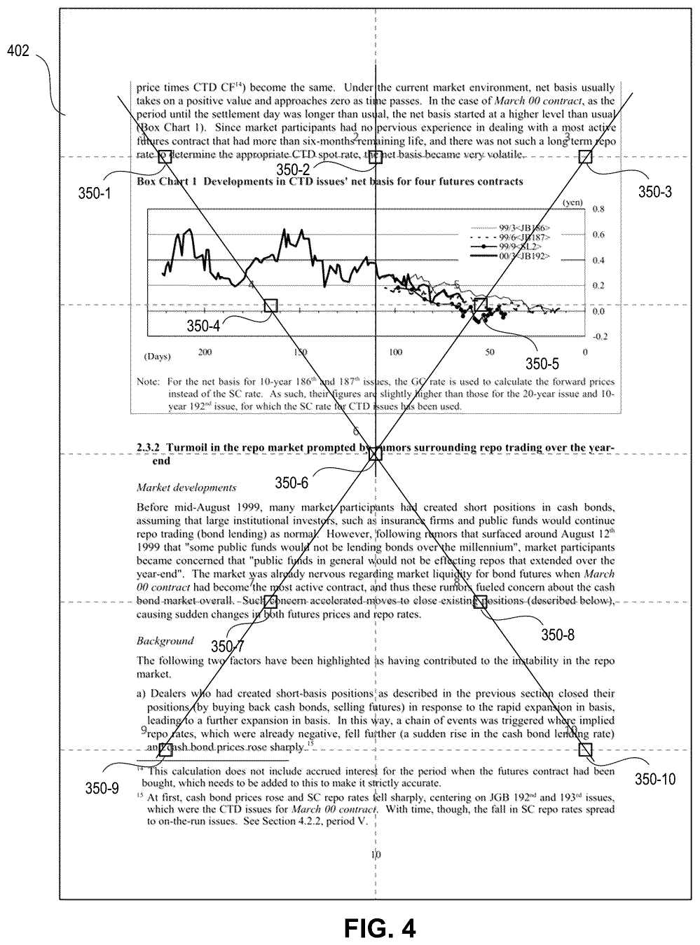

Image rescaling and cropping module 320 may also crop one or more patches 350 from input image 302. Cropped patches 350 may be processed by a second neural network 360 to generate a respective number of local feature vectors 362 that represent digital encoding of the appearance (and local artifacts) of the corresponding cropped patches. Cropped patches 350 may have a fixed size corresponding to a number of input channels of the second neural network 360, e.g., 64×64 pixels, 64×36 pixels, 32×32 pixels, or any other size. Cropped patches 350 may be taken from various locations of input image 302 selected to provide a representative coverage of various artifacts and imperfections of input image 302 across a wide area of input image 302. FIG. 4 illustrates patches cropped from an example input image 402 of a document, in accordance with some implementations of the present disclosure. Although FIG. 4 illustrates ten cropped patches 350-1 . . . 350-10, any other number of patches, e.g., 5-40 patches, may be cropped from input image 402. For some kinds of images/documents and industrial applications, it may be experienced that a large number of cropped patches (e.g., more than 10-20), while marginally improving classification efficiency of IAAM 116, comes at a cost of an increased processing and memory use and, therefore, need not always be used for classification of large volumes of documents encountered in many applications, and that a smaller number of cropped patches may be sufficient.

Illustrated cropped patches 350-1 . . . 350-10 probe a wide area of input image 402 (with two patches sampling each quadrant of input image 402 and two additional cropped patches 350-2 and 350-6 sampling the central line of input image 402, as shown) that is likely to have text, graphics or other content but do not extend all the way to the margins of input image 402 that more likely to depict a background of input image 402 but less likely to capture its content. In some implementations, sampling from the margins of an image may still be valuable since even content-free regions of images may include important artifacts that can be representative of the source of the images. In some implementations, locations of cropped patches 350-n may be selected according to a predetermined pattern (as illustrated in FIG. 4). In some implementations, locations of cropped patches 350-n may be selected randomly. In some implementations, locations of cropped patches 350-n may be selected according to some probability distribution, such that patches may be cropped from the central region of an image with a higher probability than from outer regions of the image (or vice versa, since in some instances, margins of an image may have more defects, distortions, and/or other artifacts).

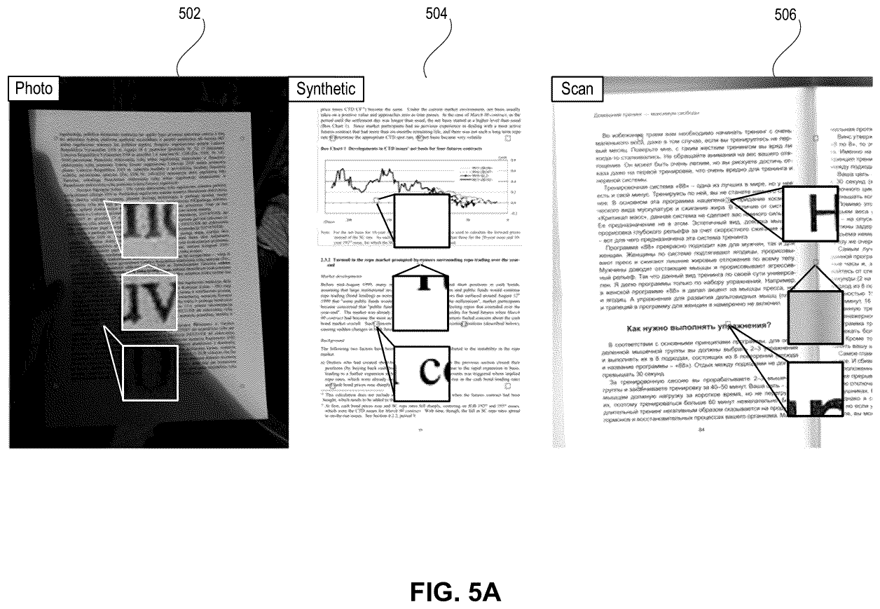

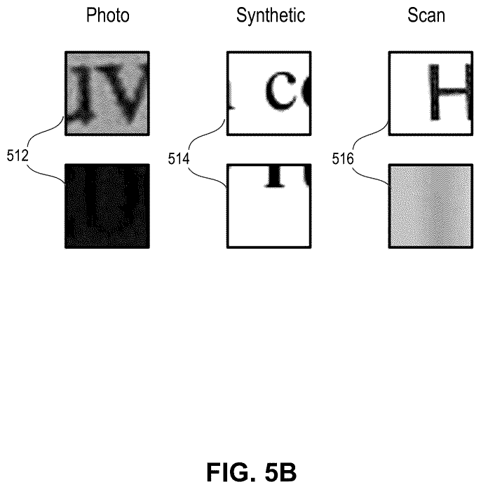

FIG. 5A illustrates example input images and patches cropped from the example input images associated with different source types, in accordance with some implementations of the present disclosure. More specifically, FIG. 5A illustrates a photographic image 502, a synthetic (digital) image 504, and a scanned image 506. Three illustrative patches for each of the images are shown with squares depicting magnified views of underlying image portions. Patches of the synthetic image 504 have a clean, artifact-free appearance, patches of the scanned image 506 have a noticeable amount of a blur and some crease artifacts, and patches of the photographic image 502 have even more significant blur, strong and non-uniform shading, and other artifacts. FIG. 5B is a side-by-side view of some of the cropped patches of FIG. 5A: patches 512 of the photographic image 502, patches 514 of the synthetic (digital) image 504, and patches 516 of the scanned image 506.

Referring again to FIG. 3, in some implementations the second neural network 360 that processes cropped patches 350 may have an architecture that is similar to the architecture of the first neural network 340. In some implementations, the second neural network 360 may have an architecture that is simplified, e.g., with fewer input channels, fewer internal channels, fewer number of layers of convolutions, and/or the like, compared with the architecture of the first neural network 340. Multiple cropped patches 350 may be processed by the second neural network 360 concurrently, e.g., by combining different cropped patches into a batch (tensor) with BatchLength of 4, 5, 8, 10, or some other number of cropped patches 350. The second neural network 360 may output a separate local feature vector 362 (also sometimes referred to as a sub-vector in this disclosure) for each cropped patch 350.

Global feature vector 342 and local feature vectors 362 may be joined, e.g., concatenated, into a combined feature vector 370, which thus encodes a combination of the overall appearance of input image 302 with appearance of its local artifacts probed via cropped patches 350. Combined feature vector 370 may be processed by a classifier 380 trained to determine class probabilities {P}382 that input image 302 belongs to one of the corresponding classes {Cⱼ}. Classifier 380 may include one or more fully-connected layers of neurons and an output layer, e.g., a softmax layer or some other layer that convers logits output by the fully-connected layer(s) to the set of class probabilities 382. A particular value Pⱼ determines the probability that input image 302 belongs to a corresponding class Cⱼ. In some implementations, the set of classes {Cⱼ} may be the same as the set of classes {cᵢ} defined for MPM 114 (as described in conjunction with FIGS. 2A-2B). In some implementations, the set of classes {Cⱼ} may differ from the set of classes {cᵢ} by at least one class. For example, images of documents of a specific source type (e.g., synthetic images) may commonly lack metadata information. In such instances, the set of classes {cᵢ} need not have a class defined for that source type since metadata-based classification would not be performed for such images (or would result in such images classified as belonging to the unknown, c₀, class). On the other hand, the set of classes {Cⱼ} of classifier 380 may include all classes that are of interest to the end user. In some implementations, the set of probabilities {Pⱼ} is normalized, ΣⱼPⱼ=1, the unknown class C₀ is not defined, and the probability for the unknown class C₀ is not output by classifier 380. In some implementations, the unknown class C₀ may still be defined even for classifier 380 to account for a possibility of input documents that are of a type previously unseen by IAAM 116.

A final source type classification 390 may be determined based on the largest probability Pₘₐₓ. The corresponding class may be identified as the most likely source type for input image 302. Based on the determined source type classification 390, input image 302 may undergo image preprocessing 270 corresponding to the determined source type, which may be followed with OCR 118, OR 119, and/or any other computer vision technique as may be defined by the user. In some implementations, additional operations may be performed that do not amount to computer vision, e.g., input image(s) 302 may be stored and/or annotated differently, depending on the determined source type.

During training, the output probabilities Pⱼ (the training outputs) may be evaluated using a loss function 385 that compares the output probabilities Pⱼ to a ground truth (the target outputs), which may include correct source types for the training images. The difference between the training outputs and the ground truth may be backpropagated (as depicted schematically with dashed arrows in FIG. 3), through the first neural network 340, the second neural network 360, and classifier 380, and the parameters (e.g., neuron weights and biases) may be suitably adjusted, e.g., using gradient descend techniques, to reduce the difference. Loss function 385 may be the (binary or multi-class) cross-entropy loss function, the center loss function, the hinge loss function, the Sørensen-Dice loss function, the weighted dice loss function, the focal loss function, and/or any other suitable loss function, and/or a combination thereof. In some implementations, for control of the speed of (gradient descent) training, a training engine may use the Adam Optimizer and the Cosine Scheduler with Warm-Up.

In some implementations, various parts of IAAM 116 may be trained together, end-to-end, with parameters of the first neural network 340, the second neural network 360, and the classifier 380 being adjusted based on the same set of training images.

In some implementations, some or each of the first neural network 340, the second neural network 360, and classifier 380 may include at least one dropout layer. The dropout layer(s) may randomly set a certain fraction r (e.g., r=0.2, 0.3, and so on) of initial or intermediate inputs into various layers of the corresponding networks to zero during processing of a particular batch of training input images. The inputs that are not set to zero may be increased by the factor 1/(1−r), such that the sum over all inputs remains unchanged. For example, during training, some components of combined feature vector 370 may be randomly set to zero before being input into classifier 380. The dropout techniques prevent overfitting and help with more uniform and robust training of different neurons of IAAM 116.

In some implementations, training of different models of ICE 112, e.g., MPM 114 and IAAM 116, may be performed using the same datasets. In some implementations, training of MPM 114 and IAAM 116 may be performed using different datasets. More specifically, since metadata tags directly refer to the source of images but may have little or no association with the actual content of the images, MPM 114 may be trained using a first dataset of arbitrary training images, including images that may be of limited relevance to the end user, e.g., photographs of outdoor scenery, scans of book pages, magazines, and/or documents from a field that is different from the target domain of the end user. IAAM 116 may be trained using a second dataset of training images that includes images that have a closer relation to the user's target domain, e.g., forms, invoices, bills, receipts, and/or other documents taken from the user's database or common in the user's industry. Correspondingly, in some implementations, MPM 114 may be trained on developer's side whereas IAAM 116 may be trained on the user's side (using a copy of training engine 152 provided to the user's computing device, e.g., computing device 110 in FIG. 1). In some implementations, IAAM 116 may be pre-trained on the developer's side using a training dataset of documents commonly encountered by many vendors and then additionally trained on the user's side using the user's own images/documents.

For the sake of example and not limitation, the first training dataset may include 1 to 20 thousands of photographs and several hundred to several thousands of scanned documents (with 15-35% of those documents used during a post-training validation stage to assess confidence of inference). Similarly, the second training dataset may include 5-50 thousands of photographs, 1-30 thousands of scanned documents, 1-30 thousands of synthetic (digital) documents (with some portion of those documents used during the validation stage).

Training of IAAM 116 may be performed using multiple epochs, e.g., 50-500 epochs, each epoch having multiple batches of training images, e.g., 20-400 batches per epoch, each batch including 50-300 training images. In some implementations, training of IAAM 116 may use variable learning rate, e.g., starting with the learning rate 10-2-10-1 and gradually decreasing the learning rate to 10-4-10-3. In some implementations, the learning rate may be periodically returned to the initial value, e.g., after every 20-50 epochs. Any other adaptive learning rate schemes may be used (including using a fixed learning rate).

In some implementations, training of IAAM 116 may include various augmentations of training images, e.g., rotations (e.g., from the portrait orientation to the landscape orientation and back), horizontal and/or vertical reflections, horizontal and/or vertical shifts, gamma-correction of pixel luminance values, grayscaling of training images, and/or other augmentations.

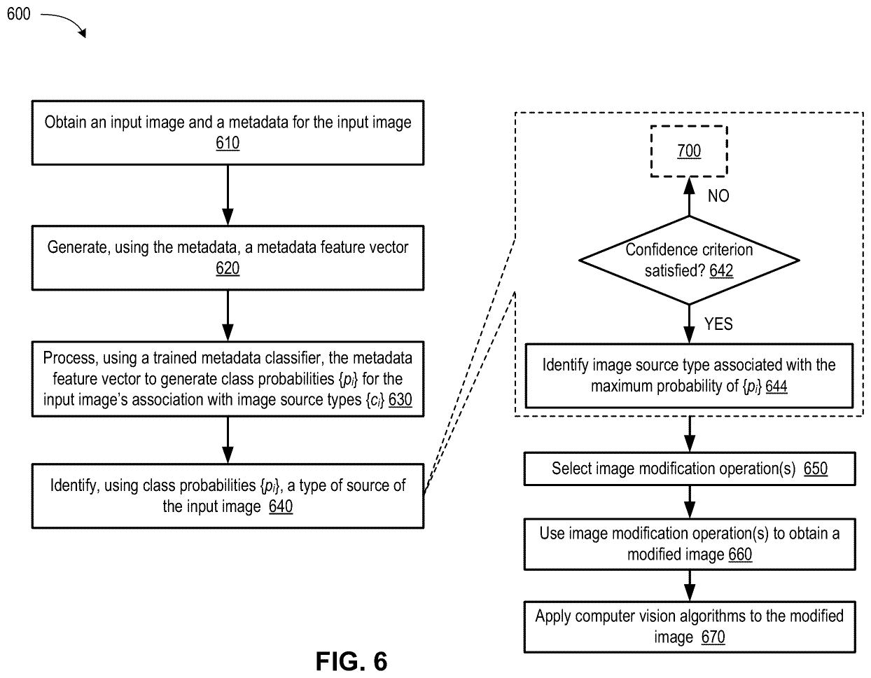

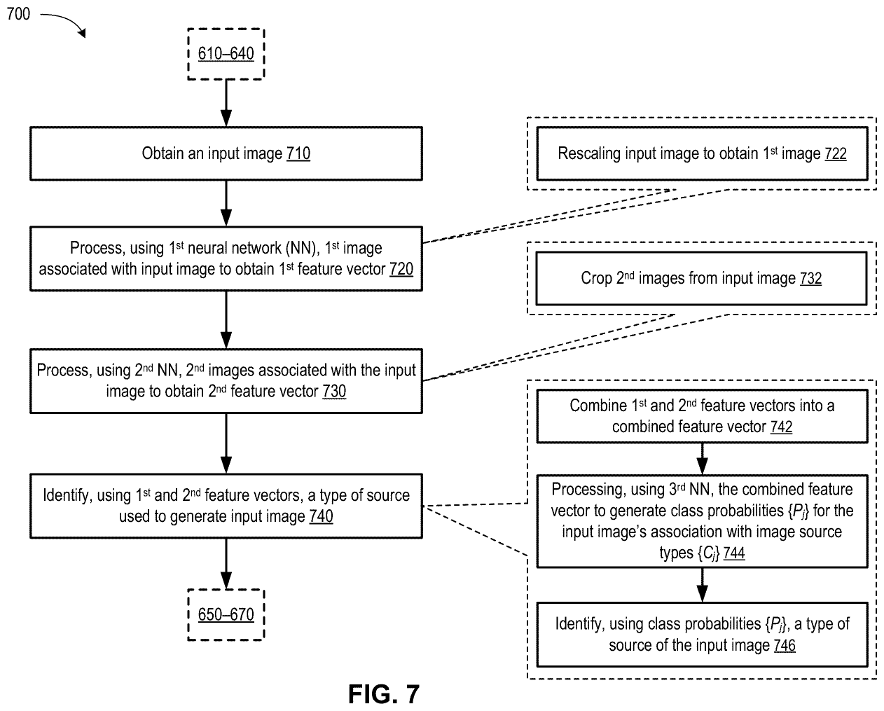

FIGS. 6-7 illustrate example methods 600-700 that can be used for efficient classification of images by source types, in accordance with some implementations of the present disclosure. A processing device, having one or more processing units (CPUs) and memory devices communicatively coupled to the CPU(s), may perform methods 600-700 and/or each of their individual functions, routines, subroutines, or operations. The processing device executing methods 600-700 may be a processing device of the computing device 110 of FIG. 1. In certain implementations, a single processing thread may perform methods 600-700. Alternatively, two or more processing threads may perform methods 600-700, each thread executing one or more individual functions, routines, subroutines, or operations of the methods. In an illustrative example, the processing threads implementing methods 600-700 may be synchronized (e.g., using semaphores, critical sections, and/or other thread synchronization mechanisms). Alternatively, the processing threads implementing methods 600-700 may be executed asynchronously with respect to each other. Various operations of methods 600-700 may be performed in a different order compared with the order shown in FIGS. 6-7. Some operations of methods 600-700 may be performed concurrently with other operations. Some operations may be optional.

FIG. 6 is a flow diagram illustrating an example method 600 of metadata-based classification of images by source types, in accordance with some implementations of the present disclosure. At block 610, a processing device performing method 600 may obtain an input image and may further obtain a metadata associated with the input image. In some implementations, at least some of the metadata may characterize the make, model, and/or settings of the image-taking device (e.g., a camera, a scanner, etc.) that generated the input image. At block 620, method 600 may continue with the processing device generating, using the metadata, a metadata feature vector (e.g., TagVec, as illustrated in FIG. 2B). At block 630, method 600 may include processing, using a trained metadata classifier (e.g., metadata classifier 230 of FIG. 2A and FIG. 2B), the metadata feature vector to generate a plurality of probabilities (e.g., class probabilities{pᵢ}, as described in conjunction with FIG. 2A and FIG. 2B). Each probability pᵢ of the plurality of probabilities {pᵢ} may characterize a likelihood that the input image is associated with a respective image source type (e.g., class cᵢ) of a plurality of image source types (e.g., a set of classes {cᵢ}). In some implementations, the trained metadata classifier may include one or more decision trees trained using a gradient boosting algorithm.

At block 640, method 600 may include identifying, using the plurality of probabilities {pᵢ}, a type of source used to generate the input image. In some implementations, block 640 may include operations illustrated with the callout portion of FIG. 6. More specifically, at decision-making block 642, the processing device performing method 600 may determine if the plurality of probabilities {pᵢ} satisfies a confidence criterion. For example, the confidence criterion may include identifying a maximum probability pₘₐₓ of the plurality of probabilities {pᵢ} and comparing pₘₐₓ with a threshold probability pr. If the confidence criterion is satisfied (e.g., pₘₐₓ>p_{T}), method 600 may continue to block 644, where identification of an image source type may be performed, e.g., by identifying the image source type (class cₘₐₓ) associated with the maximum probability Pₘₐₓ.

In some implementations, method 600 may continue, at block 650, with selecting, based on the identified type of source, one or more image modification operations, including but not limited to denoising, filtering, defect removal, lighting modification, glare removal, brightness homogenization, contrast/color sharpening, and/or any other image preprocessing operations, and/or any combination thereof. At block 660, the processing device performing method 600 may apply the one or more selected image modification operations to the input image to obtain a modified image. At block 670, method 600 may include applying one or more computer vision algorithms to the modified image, e.g., OCR, OR, or any other suitable algorithm.

In those instances, where, at block 642, the confidence criterion is not satisfied (e.g., where pₘₐₓ<p_{T}), method 600 may continue with performing classification of the input image using various operations of method 700, as described in more detail in conjunction with FIG. 7.

FIG. 7 is a flow diagram illustrating an example method 700 of classification of images by source types based on a combination of global and local appearance features of the images, in accordance with some implementations of the present disclosure. At block 710, method 700 may include obtaining an input into an image processing operation (referred to as IPO input below). The IPO input may include an input image and (in some instances) a metadata for the input image. In some implementations, e.g., when at least some metadata is present, method 700 may be preceded with operations 610-640 of method 600, e.g., performed as described in conjunction with FIG. 6. In some instances, e.g., where no metadata is present, operations 610-640 of method 600 may be skipped and processing of the input image may begin directly with operations of method 700.

At block 720 method 700 may include processing, using a first NN (e.g., the first NN 340 in FIG. 3), a first image associated with the IPO input to obtain a first feature vector (e.g., global feature vector 342). As illustrated with the top callout portion of FIG. 7, the first image (e.g., rescaled image 330) may be obtained, at block 722, by rescaling the input image.

At block 730, method 700 may include processing, using a second NN (e.g., the second NN 360), a plurality of second images associated with the IPO input to obtain a second feature vector. In some implementations, the second feature vector may include a plurality of sub-vectors (e.g., a plurality of local feature vectors 362). Each of the plurality of sub-vectors may be obtained by processing, using the second NN, a respective second image of the plurality of second images. As illustrated with the middle callout portion of FIG. 7, the plurality of second images (e.g., cropped parches 350) may be cropped, at block 732, from the input image.

At block 740, method 700 may include identifying, using the first feature vector and the second feature vector, a type of source used to generate the IPO input. In some implementations, the identified type of source may be selected from a set of classes that includes two or more of a camera-acquired image class, a scanning device-acquired image class, or a synthetic image class. In some implementations, the type of source is identified from a set of classes that may include any additional classes.

As illustrated with the bottom callout portion of FIG. 7, identifying the type of source used may include, at block 742, obtaining a combined feature vector (e.g., combined feature vector 370 in FIG. 3) that includes the first feature vector and second feature vector. At block 744, method 700 may include processing, using a third NN (e.g., classifier 380 in FIG. 3), the combined feature vector to generate a plurality of probabilities (e.g., class probabilities {Pⱼ}). Each of the plurality of probabilities {Pⱼ} may characterize a likelihood that the IPO input is associated with a respective image source type (e.g., class Cⱼ) of a plurality of image source types (e.g., a set of classes {Cⱼ}). In some implementations, the set of classes {Cⱼ} may be the same as the set of classes {cⱼ}. In some implementations, the set of classes {Cⱼ} may be different from the set of classes {cᵢ} (e.g., may include one or more classes not included in the set of classes {cᵢ}). At block 746, method 700 may include identifying, using the plurality of probabilities {Pⱼ}, the type of source used to generate the IPO input. For example, identification of the image source type may be performed by identifying the image source type (e.g., class Cₘₐₓ) associated with the maximum probability Pₘₐₓ.

In some implementations, each of the first NN and the second NN may include one or more convolutional layers of neurons. In some implementations, the third NN may include one or more fully-connected layers of neurons. In some implementations, at least one of the first NN or the second NN may include a MobileNetV3 neuron architecture. In some implementations, at least one of the first NN, the second NN, or the third NN may be trained using a neuron dropout technique. In some implementations, at least one of the first NN, the second NN, or the third NN may be trained using a variable learning rate. In some implementations, the first NN, the second NN, and the third NN are trained concurrently (e.g., end-to-end) using a common set of training inputs.

FIG. 8 depicts an example computer system 800 that can perform any one or more of the methods described herein, in accordance with some implementations of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 818, which communicate with each other via a bus 830.

Processing device 802 (which can include processing logic 803) represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 822 for implementing ICE 112, MPM 114, and/or IAAM 116 of FIG. 1 and to perform the operations discussed herein (e.g., methods 600-700 illustrated with FIGS. 6-7).

The computer system 800 may further include a network interface device 808. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker). In one illustrative example, the video display unit 810, the alphanumeric input device 812, and the cursor control device 814 may be combined into a single component or device (e.g., an LCD touch screen).

The data storage device 818 may include a computer-readable storage medium 824 on which is stored the instructions 822 embodying any one or more of the methodologies or functions described herein. The instructions 822 may also reside, completely or at least partially, within the main memory 804 and/or within the processing device 802 during execution thereof by the computer system 800, the main memory 804 and the processing device 802 also constituting computer-readable media. In some implementations, the instructions 822 may further be transmitted or received over a network 820 via the network interface device 808.

While the computer-readable storage medium 824 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
obtaining an input into an image processing operation (IPO input);
processing, using a first neural network (NN), a first image associated with the IPO input to obtain a first feature vector;
processing, using a second NN, a plurality of second images associated with the IPO input to obtain a second feature vector; and
identifying, using the first feature vector and the second feature vector, a type of source used to generate the IPO input.

2. The method of claim 1, wherein identifying the type of source used to generate the IPO input comprises:
obtaining a combined feature vector comprising the first feature vector and second feature vector;
processing, using a third NN, the combined feature vector to generate a plurality of probabilities, wherein each of the plurality of probabilities characterizes a likelihood that the IPO input is associated with a respective image source type of a plurality of image source types; and
identifying, using the plurality of probabilities, the type of source used to generate the IPO input.

3. The method of claim 2, wherein the third NN comprises one or more fully-connected layers of neurons, and wherein each of the first NN and the second NN comprises one or more convolutional layers of neurons.

4. The method of claim 2, wherein at least one of the first NN, the second NN, or the third NN is trained using a neuron dropout technique.

5. The method of claim 2, wherein at least one of the first NN, the second NN, or the third NN is trained using a variable learning rate.

6. The method of claim 2, wherein the first NN, the second NN, and the third NN are trained concurrently using a common set of training inputs.

7. The method of claim 1, wherein at least one of the first NN or the second NN comprises a MobileNetV3 neuron architecture.

8. The method of claim 1, wherein the second feature vector comprises a plurality of sub-vectors, wherein each of the plurality of sub-vectors is obtained by processing, using the second NN, a respective second image of the plurality of second images.

9. The method of claim 1, wherein the identified type of source used to generate the IPO input is selected from a set of classes, wherein the set of classes comprises at least two of:
a camera-acquired image class,
a scanning device-acquired image class, or
a synthetic image class.

10. The method of claim 1, further comprising, prior to processing the first image:
obtaining a metadata associated with the IPO input;
generating, using the metadata, a metadata feature vector;
processing, using a metadata classifier, the metadata feature vector, to generate a plurality of probabilities, wherein each of the plurality of probabilities characterizes a likelihood that the IPO input is associated with a respective image source type of a plurality of image source types; and
determining that the plurality of probabilities fails to satisfy a confidence criterion.

11. The method of claim 1, wherein the IPO input comprises an input image, the method further comprising:
rescaling the input image to obtain the first image; and
cropping the plurality of second images from the input image.

12. The method of claim 11, further comprising:
selecting, based on the identified type of source, one or more image modification operations;
applying the one or more image modification operations to the input image to obtain a modified image; and
applying one or more computer vision algorithms to the modified image.

13. A method comprising:
obtaining an input image and a metadata associated with the input image;
generating, using the metadata, a metadata feature vector;
processing, using a trained metadata classifier, the metadata feature vector to generate a plurality of probabilities, wherein each of the plurality of probabilities characterizes a likelihood that the input image is associated with a respective image source type of a plurality of image source types; and
identifying, using the plurality of probabilities, a type of source used to generate the input image.

14. The method of claim 13, wherein identifying the type of source used to generate the input image comprises:
responsive to the plurality of probabilities satisfying a confidence criterion, identifying, from the plurality of image source type, an image source type associated with a maximum probability of the plurality of probabilities.

15. The method of claim 13, wherein identifying the type of source used to generate the input image comprises:
responsive to the plurality of probabilities not satisfying a confidence criterion, generating, using the input image, a first image and a plurality of second images;
processing, using a first neural network (NN), the first image to obtain a first feature vector;
processing, using a second NN, the plurality of second images associated with the IPO input to obtain a second feature vector; and
identifying, using the first feature vector and the second feature vector, the type of source used to generate the IPO input.

16. The method of claim 13, wherein the trained metadata classifier comprises one or more decision trees trained using a gradient boosting algorithm.

17. A system comprising:
a memory; and
a processing device communicatively coupled to the memory, the processing device to:
obtain an input into an image processing operation (IPO input);
process, using a first neural network (NN), a first image associated with the IPO input to obtain a first feature vector;
process, using a second NN, a plurality of second images associated with the IPO input to obtain a second feature vector; and
identify, using the first feature vector and the second feature vector, a type of source used to generate the IPO input.

18. The system of claim 17, wherein to identify the type of source used to generate the IPO input the processing device is to:
obtain a combined feature vector comprising the first feature vector and second feature vector;
process, using a third NN, the combined feature vector to generate a plurality of probabilities, wherein each of the plurality of probabilities characterizes a likelihood that the IPO input is associated with a respective image source type of a plurality of image source types; and
identify, using the plurality of probabilities, the type of source used to generate the IPO input.

19. The system of claim 17, wherein the identified type of source used to generate the IPO input is selected from a set of classes, wherein the set of classes comprises at least two of:
a camera-acquired image class,
a scanning device-acquired image class, or
a synthetic image class.

20. The system of claim 17, wherein the processing device is further to:
prior to processing the first image, obtain a metadata associated with the IPO input;
generate, using the metadata, a metadata feature vector;
process, using a metadata classifier, the metadata feature vector, to generate a plurality of probabilities, wherein each of the plurality of probabilities characterizes a likelihood that the IPO input is associated with a respective image source type of a plurality of image source types; and
determine that the plurality of probabilities fails to satisfy a confidence criterion.
